(19) United States
(12) Patent Application Publication
(10) Pub. No.: US 2021/0016841 A1
(43) Pub. Date: Jan. 21, 2021

(54) VEHICLE STRUCTURE WITH UNIFORM ADHESIVE BOND FOR DIE CAST ALUMINUM COMPONENTS, AND RELATED METHODS

(71) Applicant: VOLVO CAR CORPORATION, Göteborg (SE)

(72) Inventors: Marcus SCHMIDT, Åsa (SE); Rebecca ANDERSSON, Göteborg (SE); Austen CLARK, Göteborg (SE)

(21) Appl. No.: 16/517,367

(22) Filed: Jul. 19, 2019

(51) Int. Cl. B62D 27/02; B62D 29/00; B62D 29/04

(52) U.S. Cl. CPC B62D 27/026; B62D 27/065; B62D 29/043; B62D 29/008

(57) ABSTRACT

A vehicle structure is provided that includes at least a die cast aluminum first vehicle component adhesively bonded to a second vehicle component made of a material other than die cast aluminum, in which the adhesive bond line between the bonding surface areas of the vehicle components is made uniform in thickness by the provision of aluminum protrusions of identical height to one another integrally die cast with and extending from the bonding surface area of the first vehicle component to contact the second vehicle component. Optionally, the adhesive bond is reinforced with one or more mechanical fasteners. Also provided is a method of making the vehicle structure.

### TECHNICAL FIELD

The present invention relates to the adhesive bonding of a die cast metal vehicle component, particularly die cast metal components made of aluminum and an aluminum alloy, to another vehicle component, particularly one having a different thermal expansion coefficient than the die cast metal.

### BACKGROUND ART

In recent years, the automotive industry has come under increased pressure to make vehicles (e.g., sedans, coupes, sports utility vehicles (also known as SUVs), hatchbacks, etc.) that are more fuel efficient. The pressure has come largely from consumer wanting to pay less money at the gas pump, and governments placing fuel economy standards on vehicle manufacturers.

One way in which to increase fuel economy is to reduce the weight of the vehicle. Because aluminum has a relatively high strength and durability and low weight, many manufacturers have turned to aluminum as a replacement for steel parts. In many of today's vehicles, aluminum has been incorporated into almost all of the parts of the vehicle, including, for example, body panels and engines. Die casting is an efficient and economical technique for shaping aluminum into its desired component part shape, and therefore is commonly used in the automotive industry.

The incorporation of aluminum into vehicles has not been without its problems. Aluminum is not a suitable replacement or the most desirable replacement for all steel parts. Accordingly, the production of a vehicle often involves joining aluminum parts to vehicle parts made of other materials, such as steel. Adhesive bonding is a particularly economical and useful way of joining parts together.

However, aluminum has a different coefficient of thermal expansion than the parts to which it is sometimes adhesively bonded. The coefficient of thermal expansion (CTE) of aluminum per degree of temperature change centigrade at 20° C. is about 24×10⁻⁶/° C. In comparison, steel and carbon fiber composite, which are two materials commonly found in vehicles, have a CTE of 12×10⁻⁶ and zero (0), respectively.

Mismatched CTEs of different materials adhesively joined together can cause one of the materials, typically the aluminum, to undergo greater expansion than the other material, typically steel or carbon fiber composite, when the components are subject to a severe temperature change. If the adhesive bond line is not uniform, the CTE difference can create non-uniform shear strain along the adhesive bond line during the heating and/or cooling stages of high temperature production steps, such as in the case of paint shop oven heating, where the parts may be heated at temperatures on the order of about 180° C. to about 200° C.

### SUMMARY

Accordingly, it is an object of the invention to provide a solution to the problems created by non-uniform shear strain along an adhesive bond line that is subject to high temperature production steps.

According to an aspect of the invention, a vehicle structure and a method involve a die cast aluminum first vehicle component adhesively bonded to a second vehicle component made of a material other than die cast aluminum, in which the adhesive bond line between the bonding surface areas of the vehicle components is made uniform in thickness by the provision of aluminum protrusions of identical height to one another integrally die cast with and extending from the bonding surface area of the first vehicle component to contact the second vehicle component. Optionally, the adhesive bond is reinforced with one or more mechanical fasteners.

The identical height of the integrally die cast protrusions creates a uniform gap between the bonding surface areas of the first and second vehicle components equal in thickness to the height of the protrusions. Because the adhesive conforms to the uniform gap, the adhesive has a uniform thickness. As a result, the adhesive bond line is better suited to withstand variations in temperature, including those experienced during vehicle production.

According to another aspect of the invention, a vehicle structure and a method involve a die cast aluminum first vehicle component adhesively bonded to a second vehicle component made of aluminum or an aluminum alloy, in which the adhesive bond line between the bonding surface areas of the vehicle components is made uniform in thickness by the provision of aluminum protrusions of identical height to one another integrally die cast with and extending from the bonding surface area of the first vehicle component to contact the second vehicle component. Optionally, the adhesive bond is reinforced with one or more mechanical fasteners. Although differing rates of thermal expansion are of less or no concern where both components are made of aluminum, the uniformity of the adhesive bond line provides improved bond strength.

Other aspects and embodiments of the invention, including vehicles, structures, components, assemblies, apparatus, kits, bonded parts and objects, methods and processes of making and using, and the like which constitute part of the invention, will become more apparent upon reading the following detailed description of the exemplary embodiments.

### BRIEF DESCRIPTION OF THE DRAWINGS

The accompanying drawings are incorporated in and constitute a part of the specification. The drawings, together with the general description given above and the detailed description of the exemplary embodiments and methods given below, serve to explain principles of the invention. In such drawings:

FIG. 1 is a fragmented view of a vehicle component according to a first embodiment of the invention;

FIG. 2 is an enlarged, fragmented, partially sectioned view of the vehicle component of the first embodiment taken within circle 2 of FIG. 1;

FIG. 3 is a fragmented view of a vehicle component according to a second embodiment of the invention;

FIG. 4 is an enlarged, fragmented, partially sectioned view of the vehicle component of the second embodiment taken within circle 4 of FIG. 2;

FIG. 5 is a perspective view of a vehicle structure according to a third embodiment of the invention;

FIG. 6 is an enlarged, fragmented, cross-sectional view of the vehicle structure of the third embodiment taken along sectional line 6-6 of FIG. 5; and

FIG. 7 is an enlarged, fragmented, cross-sectional view of the vehicle structure of the third embodiment modified to include a mechanical fastener.

### DESCRIPTION OF EMBODIMENTS

Reference will now be made in detail to the exemplary embodiments and exemplary methods as illustrated in the accompanying drawings, in which like reference characters designate like or corresponding parts throughout the drawings. It should be noted, however, that the invention in its broader aspects is not necessarily limited to the specific details, representative materials and methods, and illustrative examples shown and described in connection with the exemplary embodiments and exemplary methods.

It should be understood that the principles and features of the present invention may be applied to various vehicles, including sedans, coupes, sport utility vehicles (SUVs), hatchbacks, crossovers, etc. The principles of the present invention are applicable to gas-driven vehicles, electric-powered vehicles, hybrids, diesel, and other types of powered and non-powered vehicles.

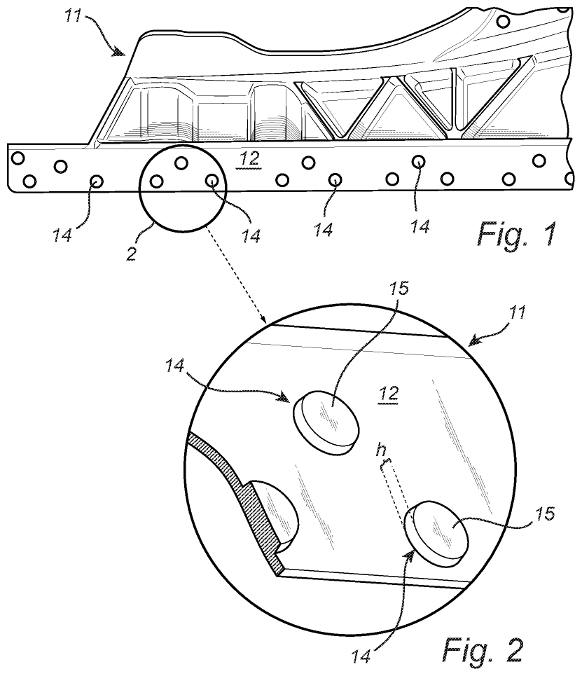

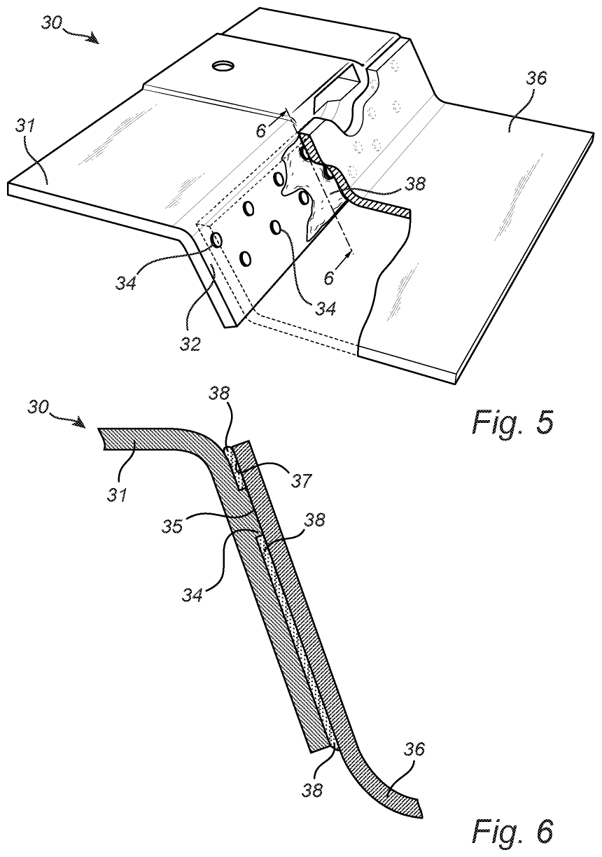

A die cast aluminum first vehicle component according to a first exemplary embodiment of the invention is generally designated by reference numeral 11 in FIGS. 1 and 2. The die cast aluminum first vehicle component 11 may be, for example, a frame, frame part, body panel, engine part, or other part of the vehicle. The die cast aluminum first vehicle component 11 includes a bonding surface area 12, which is shown in FIGS. 1 and 2 as a planar area. It should be understood that the bonding surface area 12 may be, for example, concave or convex, preferably with the second vehicle component (such as second vehicle component 36 described below in connection with FIGS. 5 and 6) to be bonded thereto having a corresponding convex or concave surface.

The first vehicle component 11 may be made of aluminum or an aluminum alloy having a first coefficient of thermal expansion (CTE). The CTE may be, for example, 20×10⁻⁶/° C. to 24×10⁻⁶/° C. at 20° C. Commercial grade aluminum and aluminum alloys are well known in the automobile industry, and are particularly useful for the purposes of this invention.

The first vehicle component 11 includes multiple protrusions 14 having an identical height “h” (FIG. 2) to one another extending from the first bonding surface area 12. The first vehicle component 11 may have one, two, three, four, or more protrusions 14 along the first bonding surface area 12. The protrusions 14 are shown spaced from one another, surrounded by the first bonding surface area 12 configured to receive an adhesive. The protrusions 14 are cylindrical shaped in the embodiment illustrated in FIGS. 1 and 2. The protrusions 14 have terminal ends 15 spaced from the first bonding surface area 12 by a distance equal to height “h”. The terminal ends 15 are preferably planar and extend in a plane parallel to and spaced from the first bonding surface area 12.

As best shown in FIG. 2, the protrusions 14 are integrally formed with the surrounding planar surface area 12, and are made of the same aluminum or aluminum alloy as the remainder of the first vehicle component 11. The integrally formed protrusions 14 may be formed by die casting them (with the remainder of the first vehicle component 11) in a mold having recesses of inverse shape to the protrusions 14. In the case of the cylindrical-shaped protrusions 14, the mold recesses would be shaped as cylindrical pockets.

The protrusions may have shapes other than the cylinders shown in FIGS. 1 and 2. For example, the protrusions may be longitudinal strips, other polygonal and non-polygonal shapes, elliptical or oval shape, etc.

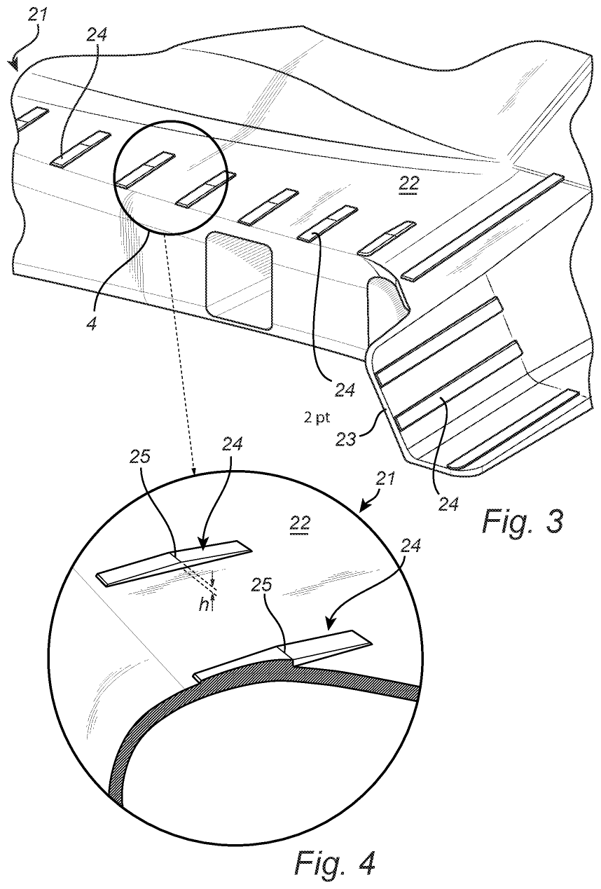

A die cast aluminum first vehicle component according to a second exemplary embodiment of the invention is generally designated by reference numeral 21 in FIGS. 3 and 4. The die cast aluminum first vehicle component 21 may be, for example, a frame, frame part, body panel, engine part, or other vehicle part. The die cast aluminum first vehicle component 21 includes a bonding surface area 22, which is shown in FIGS. 3 and 4 as a planar area. It should be understood that the bonding surface area 22 may be, for example, concave or convex, preferably with the second vehicle component to be bonded thereto having a corresponding convex or concave surface area. For example, flange 23 of the die cast aluminum vehicle component 21 has a bonding surface area 22 that is bent to provide a general “L”-shape profile.

The first vehicle component 21 may be made of aluminum or an aluminum alloy having a first coefficient of thermal expansion (CTE). The CTE may be, for example, 20×10⁻⁶/° C. to 24×10⁻⁶/° C. at 20° C. Commercial grade aluminum and aluminum alloys are well known in the automobile industry, and are particularly useful for the purposes of this invention.

The first vehicle component 21 includes multiple protrusions 24 having an identical height to one another extending from the first bonding surface area 22. The first vehicle component 21 may have one, two, three, four, or more protrusions 24 along the first bonding surface area 22. The protrusions 24 are shown spaced from one another, surrounded by the first bonding surface area 22 configured to receive an adhesive. The protrusions 24 are configured as longitudinal members or strips having an isosceles triangular profile in the embodiment illustrated in FIGS. 3 and 4. The protrusions 24 have terminal ends 25 spaced from the first bonding surface area 22 by a distance equal to height. The terminal ends 25 are illustrated as linear ridges spaced from and parallel to the first bonding surface area 22.

As best shown in FIG. 4, the protrusions 24 are integrally formed with the surrounding planar surface area 22, and are made of the same aluminum or aluminum alloy as the remainder of the vehicle component 21. The integrally formed protrusions 24 may be formed by die casting them (with the remainder of the vehicle component 21) in a mold having recesses of inverse shape to the protrusions 24. In the case of protrusions 24, the mold recesses would be shaped as grooves or pits that taper downward towards their middle, to provide the inverse shape to an isosceles triangle.

A vehicle structure according to a third exemplary embodiment of the invention is generally designated by reference numeral 30 in FIGS. 5 and 6. The vehicle structure 30 includes a die cast aluminum first vehicle component 31 and a second vehicle component 36. The first and second vehicle components 31 and 36 may be, for example, a frame, frame part, body panel, engine part, other vehicle part, or any combination thereof.

The die cast aluminum first vehicle component 31 includes a bonding surface area 32, which is shown in FIGS. 5 and 6 as a planar area. It should be understood that the bonding surface area 32 may be, for example, concave or convex, preferably with the second vehicle component 36 having a corresponding convex or concave bonding surface area.

The first vehicle component 31 may be made of aluminum or an aluminum alloy having a first coefficient of thermal expansion (CTE). The CTE may be, for example, 20×10⁻⁶/° C. to 24×10⁻⁶/° C. at 20° C. Commercial grade aluminum and aluminum alloys are well known in the automobile industry, and are particularly useful for the purposes of this invention.

The die cast aluminum first vehicle component 31 includes multiple protrusions 34 extending from the first bonding surface area 32. The protrusions 34 have an identical height “h” (FIG. 2) to one another. The vehicle component 31 may have one, two, three, four, or more protrusions 34. The protrusions 34 are preferably spaced from one another, and surrounded by the first bonding surface area 32. The protrusions 34 are configured as cylinders identical to those in the embodiment illustrated in FIGS. 1 and 2 with a height “h”. The protrusions 34 have terminal ends 35 spaced from the first bonding surface area 12 by a distance equal to height “h”. The terminal ends 35 are preferably planar and parallel to and spaced from the first bonding surface area 32.

As best shown in FIG. 6, the protrusions 34 are integrally formed with the surrounding planar surface area 32, and are made of the same aluminum or aluminum alloy as the remainder of the first vehicle component 31. The integrally formed protrusions 34 may be formed by die casting them (with the remainder of the first vehicle component 31) in a mold having recesses of inverse shape to the protrusions 34. In the case of the cylindrical-shaped protrusions 34, the mold recesses would be shaped as cylindrical pockets.

The second vehicle component 36 of the vehicle structure 30 may be made of a material other than die cast aluminum and has a second coefficient of thermal expansion that is different than the first coefficient of thermal expansion. For example, the second vehicle component 36 may be made of steel (various grades), carbon fiber reinforced composite, or other material(s). In a particularly preferred embodiment, the second vehicle component 36 is made of sheet metal, such as steel sheet metal, subject to stamping, extrusion, thermoforming, or another shaping process. In an alternative embodiment, the second vehicle component 36 may be made of aluminum or an aluminum alloy having a CTE similar or equal to that of the first vehicle component 36. For example, the second vehicle component 36 may be extruded aluminum.

The second vehicle component 36 contacts the protrusion ends 35 to space a second bonding surface area 37 of the second vehicle component 36 from the first bonding surface area 32 area by a gap. The width of the overlap between the first and second bonding surface areas 32 and 37 preferably is about 20 mm, but may be smaller or larger depending upon the size and weight of the vehicle components 31 and 36.

An adhesive 38 is contained in and fills the gap between the first and second bonding surface areas 32 and 37 to adhesively bond the first and second vehicle components 31 and 36 to one another. The adhesive 38 preferably is a high-performance structural adhesive, such as an epoxy structural adhesive or a two-component polyurethane. However, other adhesive materials may be used, such as lower performance rubber (e.g., polybutadiene adhesives).

The adhesive 38 conforms to the shape of the gap, which has a uniform thickness due to the uniform height of the protrusions 34 spacing the first bonding surface area 32 from the second bonding surface area 37. The thickness of the gap thus corresponds to the height of the protrusions 34. The gap thickness/protrusion height preferably is about 0.8 mm. However, the thickness/height maybe be greater or less than 0.8 mm, depending on the size and mass of the components 31 and 36. Generally, a greater adhesive bond line thickness is required for larger size and greater mass vehicle components 31 and 36 than smaller size and lesser mass vehicle components.

The die cast aluminum vehicle components 11 and 21 of the first and second embodiments, respectively, may be adhesively bonded to second vehicle components similar to the manner in which the vehicle component 31 is adhesively bonded to the second vehicle component 36, in the manner described above in connection with FIGS. 5 and 6 and otherwise described herein.

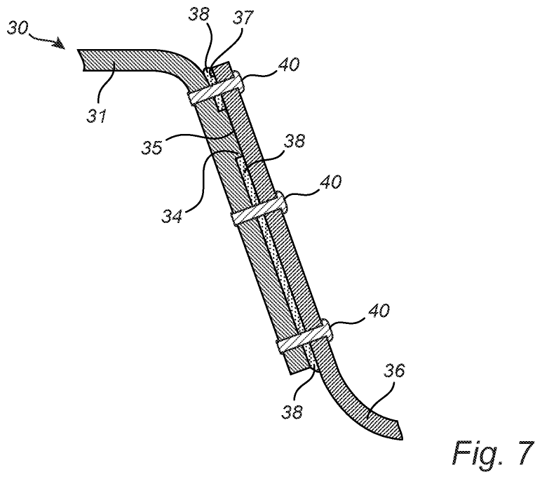

FIG. 7 illustrates a modification of the third embodiment of FIGS. 5 and 6, but is equally as applicable to the embodiments of FIGS. 1-4. The vehicle structure 30 further includes at least one, and preferably a plurality of mechanical joining elements or fasteners 40, such as rivets, flow-drill screws, other types of screws, nuts and bolts, etc. The fasteners 40 are preferably located between (and thus do not penetrate through) the protrusions 34. The pitch, i.e., distance between fasteners 40 along the bond line flange bonding surface areas 12, 22, and 32, preferably is in a range of about 40 mm to 100 mm.

A method of making the vehicle structure 30 according to an exemplary embodiment will now be discussed in further detail. The adhesive 38 is applied to the first bonding surface area 32 of the die cast aluminum first vehicle component 31 so that the adhesive 38 surrounds the protrusions 34. The second vehicle component 36 is then contacted directly with the ends of the protrusions 34, preferably without adhesive therebetween. The second bonding surface area 37 of the second vehicle component 36 is spaced from the first bonding surface area 32 by a gap equal in distance to the height of the protrusions 34 to establish an adhesive bond having a uniform thickness equal to the height of the protrusions 34. Preferably, enough of the adhesive 38 is provided to fill the gap, with excess amounts of the adhesive being allowed to seep out between the edges of the bonding surfaces areas 32 and 37, as best shown in FIG. 6. The optional fasteners 40 are then applied to provide reinforcement for the adhesive bond.

### INDUSTRIAL APPLICABILITY

The present invention has utility in connection with vehicles, including sedans, coupes, sports utility vehicles (also known as SUVs), and hatchbacks, especially (but not limited to) body panel parts.

Note that not all of the steps described above in the general description or the examples are required, that a portion of a specific step may not be required, and that one or more further steps may be performed in addition to those described. Still further, the order in which steps are described is not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention. Modifications include the combination and incorporation of different embodiments with one another.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Also, the use of “a” or “an” are employed to describe elements and components described herein. This is done merely for convenience and to give a general sense of the scope of the invention. This description should be read to include one or at least one and the singular also includes the plural, and the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination.

What is claimed is:

1. A vehicle structure comprising:
a die cast aluminum first vehicle component comprising a first bonding surface area and integrally die cast aluminum protrusions of identical height to one another extending from the first bonding surface area to terminate at protrusion ends, the die cast aluminum automotive component made of aluminum or an aluminum alloy having a first coefficient of thermal expansion;
a second vehicle component contacting the protrusion ends to space a second bonding surface area of the second vehicle component from the first bonding surface area by a gap, the second vehicle component being made of a material other than die cast aluminum and having a second coefficient of thermal expansion that is different than the first coefficient of thermal expansion; and
an adhesive in the gap between the first and second bonding surface areas adhesively joining the first and second vehicle components to one another, the adhesive having a uniform thickness equal to the height of the protrusions.

2. The vehicle structure of claim 1, wherein the die cast aluminum first vehicle component is a vehicle body panel.

3. The vehicle structure of claim 1, wherein the material of the second vehicle component is steel.

4. The vehicle structure of claim 1, wherein the material of the second vehicle component is carbon fiber reinforced plastic.

5. The vehicle structure of claim 1, wherein the protrusions are cylindrical.

6. The vehicle structure of claim 1, wherein the protrusions comprise strips.

7. The vehicle structure of claim 1, wherein the thickness of the adhesive is about 0.8 mm.

8. The vehicle structure of claim 1, wherein the first and second bonding surface areas overlap one another by a width of about 20 mm.

9. The vehicle structure of claim 1, further comprising a mechanical fastener reinforcing the adhesive joining of the first and second bonding surface areas to one another.

10. A vehicle structure comprising:
a die cast aluminum first vehicle component comprising a first bonding surface area and integrally die cast aluminum protrusions of identical height to one another extending from the first bonding surface area to terminate at protrusion ends, the die cast aluminum automotive component made of aluminum or an aluminum alloy;
a second vehicle component contacting the protrusion ends to space a second bonding surface area of the second vehicle component from the first bonding surface area by a gap, the second vehicle component being made of aluminum or an aluminum alloy; and
an adhesive in the gap between the first and second bonding surface areas adhesively joining the first and second vehicle components to one another, the adhesive having a uniform thickness equal to the height of the protrusions.

11. The vehicle structure of claim 10, wherein the die cast aluminum first vehicle component is a vehicle body panel.

12. The vehicle structure of claim 10, wherein the protrusions are cylindrical.

13. The vehicle structure of claim 10, wherein the protrusions comprise strips.

14. The vehicle structure of claim 10, wherein the thickness of the adhesive is about 0.8 mm.

15. The vehicle structure of claim 10, wherein the first and second bonding surface areas overlap one another by a width of about 20 mm.

16. The vehicle structure of claim 10, further comprising a mechanical fastener reinforcing the adhesive joining of the first and second bonding surface areas to one another.

17. A method of making a vehicle structure comprising:
providing a die cast aluminum first vehicle component comprising a first bonding surface area and integrally die cast aluminum protrusions of identical height to one another extending from the first bonding surface area to terminate at protrusion ends, the die cast aluminum automotive component made of aluminum or an aluminum alloy;
applying an adhesive to the first bonding surface area; and
contacting a second vehicle component with the protrusion ends to space a second bonding surface area of the second vehicle component from the first bonding surface area by a gap equal in distance to the height of the protrusions to establish an adhesive bond having a uniform thickness equal to the height of the protrusions.

18. The method of claim 17, wherein:
the die cast aluminum automotive component is made of aluminum or an aluminum alloy having a first coefficient of thermal expansion; and
the second vehicle component is made of a material other than die cast aluminum and has a second coefficient of thermal expansion that is different than the first coefficient of thermal expansion.

19. The method of claim 17, wherein the die cast aluminum first vehicle component is a vehicle body panel.

20. The method of claim 17, further comprising reinforcing the adhesive bond with a mechanical fastener.
